(19) United States
(12) Patent Application Publication
(10) Pub. No.: US 2009/0060255 A1
(43) Pub. Date: Mar. 5, 2009

(54) MULTI-LAYERED MEMBRANES CONSISTING OF A PLURALITY OF MATERIALS, FOR THE LOUDSPEAKER OF A HIGH FIDELITY LOUDSPEAKER CABINET

(75) Inventors: Bruno De La Nouvelle, Saint-Genest Malifaux (FR); Gerard Chretien, Brignais (FR)

Correspondence Address: ROTHWELL, FIGG, ERNST & MANBECK, P.C., 1425 K STREET, N.W., SUITE 800, WASHINGTON, DC, 20005, US

(73) Assignee: FOCAL-JMLAB (S.A), La Talaudiere (FR)

(21) Appl. No.: 12/146,902

(22) Filed: Jun. 26, 2008

Related U.S. Application Data
(63) Continuation of application No. 10/551,955, filed on Oct. 6, 2005, now abandoned.

(30) Foreign Application Priority Data
Apr. 9, 2003 (FR) 03/04420

(51) Int. Cl. H04R 1/00

(52) U.S. Cl. 381/423; 29/594

(57) ABSTRACT

The invention relates to a membrane (1) for a loudspeaker, characterised in that: it has a core (2) consisting of structural mousse which is very precisely cut and thermoformed to the desired geometric profile for the membrane; the external face (4) of the membrane is covered by at least one, preferably a plurality of, outer folds (5) of woven or nonwoven fibres impregnated with resin, forming a laminated material or outer skin (6); the inner face (7) of the membrane is covered or not by at least one inner fold (8) of woven or non-woven fibres impregnated with resin, forming a laminated material or an inner skin (9). Essentially the same results are obtained in terms of rigidity, but the invention creates a large difference based on the process for controlling the resin content and the polymerisation cycle. Ultimately, the stability of the characteristics is improved.

This application is a continuation of U.S. Ser. No. 10/551,955 filed Oct. 6, 2005, which is a 35 U.S.C. 371 National Phase Entry Application from PCT/FR04/00642 filed Mar. 16, 2004.

### FIELD OF THE INVENTION

The invention relates to the technical sector of high-fidelity sound reproduction appliances, specifically to the loudspeakers of such appliances, and more specifically to a diaphragm for such a loudspeaker.

### DESCRIPTION OF PRIOR ART

The diaphragm of a transducer ensures mechanical coupling of a moving coil which is positioned in an air gap and through which a modulated current passes and the molecules of air in order to ensure sound reproduction. In addition to geometric shape, the qualities of a diaphragm are subject to three criteria at the mechanical level: the weight of the diaphragm, its flexural strength, and its damping.

The diaphragm is customarily produced as a single-material structure, of a material offering a good compromise among the three preceding criteria. As a result, in a 16.5-cm medium-range woofer, for example, it is not possible to have the rigidity desired for ideal reproduction of the low-pitched sounds while mastering the damping for proper reproduction of the medium-pitched sound zone.

A monostructural solution does not permit individual optimization of the criteria.

Significant improvement was made by the patent filed by the applicant under number FR 95 03092, on the basis of a sandwich diaphragm of thermomolded foam both surfaces of which are covered by a glass film.

### STATEMENT OF TECHNICAL PROBLEM

The progress made in the quality of digital sources and amplification (both in musical creation and in reproduction), with increasingly wider frequency bands extending from 20 Hz to 40 kHz, make new demands of transducers:
Rigidity for base speakers increasingly subjected to rising energy levels,
Lower and lower masses for obtaining acceleration factors suitable for reproduction of the transients which such frequency responses generate,
Damping controlled in order to eliminate the acoustic “shading” inherent in the material of the diaphragm, shading which becomes more pronounced as the rigidity increases.

The problem is that these parameters are interrelated and incompatible.

Considering the new digital audio formats such as 24 bits/96 kHz, Dolby Digital, SACD, DVD Audio, et al., it is strategically important to make improvements in electrodynamic transducers such that the quality leap made by these formats ultimately becomes perceptible.

A constant factor is necessarily introduced, in that monostructural diaphragms allow of no development, since their quality is bound up with the material used. It is realistic to state that all the possibilities have been explored over the last fifty years. Single-layer composite materials exhibit the same limits.

There is thus a significant need for a diaphragm which would be further improved over the diaphragms described in the French patent cited in the foregoing while the cost of manufacture would remain compatible with the demands of the market.

### SUMMARY OF THE INVENTION

This invention employs a multilayer and multimaterial composite structure. The structure takes priority over the material with respect to rigidity. The solution proposed provides a flexural rigidity nearly 20 times greater than that of the conventional solutions for a cone of identical cover coat (6854 for this invention, as against 366 N/mm for cellulose pulp, 313 N/mm for Impregnated™, 77 N/mm for aluminum, and 42 N/mm for polypropylene).

With respect to the French patent cited in the foregoing it may be said that appreciably the same results are obtained in terms of rigidity, but an important difference is made which is based on the process in which the resin rate and the polymerization cycle are controlled. Higher stability of the characteristics is ultimately obtained.

The choice of materials, in particular those for the core of the structure, allows an adjustment at the end of damping.

As a result of the material used and the number of layers, the inner and/or outer layers permit precise adjustment of the mass and rigidity and of the speed of propagation of sound in the diaphragm.

As was stated above, this results in a large number of parameters some of which are incompatible.

The applicant has, however, succeeded in designing cost-effective multilayer, multimaterial diaphragms having greatly improved characteristics.

The unique advantage of the technology thus developed is the ability to effect mechanical adjustment of the response of a transducer by adapting the characteristics of the diaphragm to the source.

This eliminates the need in the anterior art for resort to subsequent correction by electric filtration, something which creates phase problems and alters the sound reproduction.

### DETAILED DESCRIPTION OF THE INVENTION

### Brief Description of the Drawings

FIG. 1A illustrates a diaphragm 1 claimed for the invention and FIG. 1B a detailed sectional view of the layers or “plies” of the core of this diaphragm. FIG. 2 obviously is intended to be non-restrictive.

FIGS. 2 to 9 (in each of which A represents sensitivity, B pulse response, and C schematic structure and nomenclature) present non-restrictive structures and curves illustrating their properties in relation to the non-restrictive examples given below.

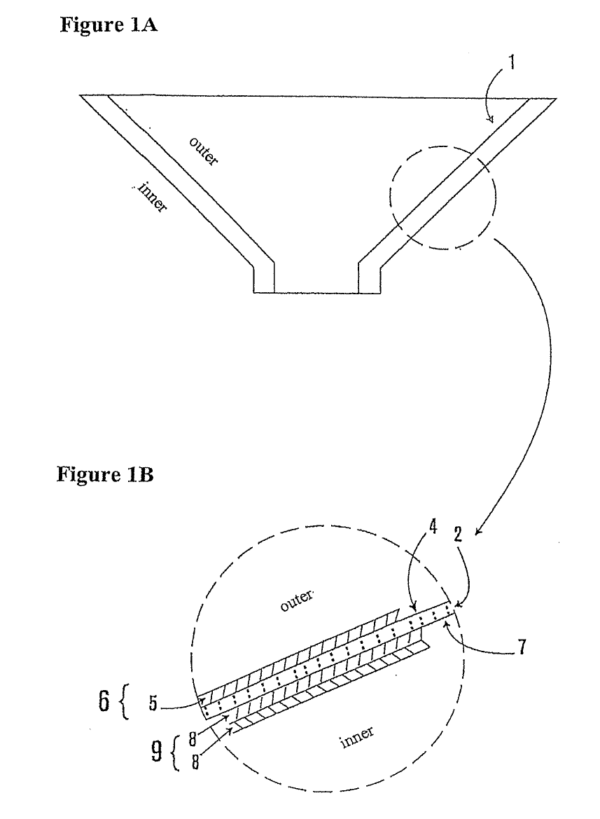

The invention thus relates to a diaphragm 1 for a loudspeaker characterized in that
it comprises a core 2 consisting of structural foam cut with very high precision and thermomolded to the geometric shape desired for the diaphragm
the outer surface 4 is covered with at least one, preferably several, “outer plies” of woven or nonwoven fibers impregnated with resin and forming a stratified skin or “outer skin” 6.
the inner surface 7 is covered or not covered with one or more “inner plies” of woven or nonwoven fibers impregnated with resin and forming a stratified skin or “inner skin” 9.

The composition of the outer skin, especially the number and nature of the “outer” plies varies as a function of the characteristics desired.

The presence of the inner skin and its composition, especially the number of the “inner” plies, varies as a function of the characteristics desired.

As non-restrictive examples, the woven or nonwoven fibers making up the inner and outer plies will be selected from the following categories:
glass fibers
carbon fibers, polyethylene fibers, aramides and para-aramides (Dynesma™, Spectra™, Kevlar™, Vectran™, etc).

The foam making up the core of the “structural” type is selected from among the following:
Plexiglas™ foam with closed cells of a density ranging from 30 to 100 kg/m³, typically 50 kg/m³
PVC (polyvinyl chloride) with closed cells of a density ranging from 50 to 200 kg/m³
polystyrene foam with closed cells of a density ranging from 15 to 40 kg/m³.

The impregnation resin selected is one of the following:
resins of the thermohardenable type: epoxy, polyester, vinylester, and phenol resins
thermoplastic resins (polyamide, polypropylene).

The expert will be able to select the materials indicated in the foregoing as a function of the properties sought by referring to the attached drawings and, optionally, by conducting simple tests.

It should be noted that use may be made of different fibers and different impregnating resins, or conversely identical ones, for producing the plies, all combinations as determined by the properties sought being possible. Use may also be made of a combination of fibers and resin for the inner plies and another combination for the outer plies, or, again, the same combination.

For industrial reasons preference will be given to use of the same combination.

This sandwich material is polymerized either by compression between mold and countermold or in vacuum molding, at a temperature permitting polymerization of the resin and accordingly a mechanically uniform structure. The invention relates to this process as well.

### EXEMPLARY EMBODIMENTS

The current method permits production of a diaphragm for base-range and medium-range transducers whose diameters vary from 46 cm to 10 cm.

Random sampling of frequency and pulse response curves has been carried out for six variations of membranes of the same diameter for a 165-mm loudspeaker.

The thicknesses of the inner and outer plies were varied by slicing the material to obtain different thicknesses ranging from 1.6 mm to 4 mm.

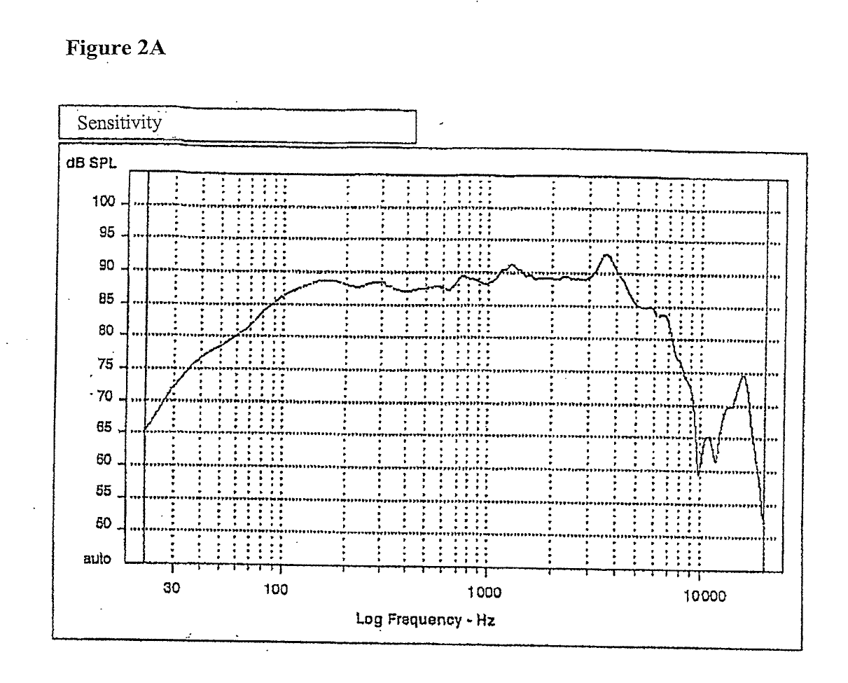

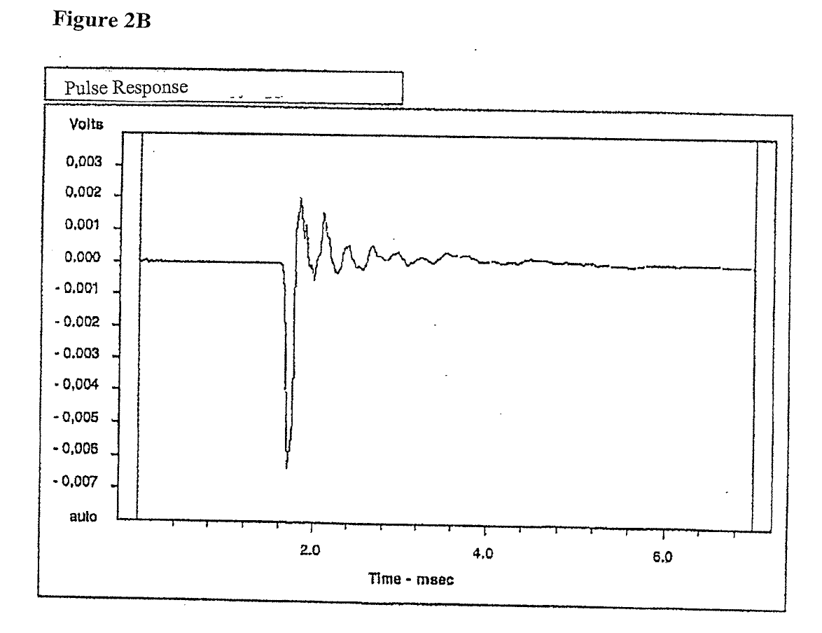

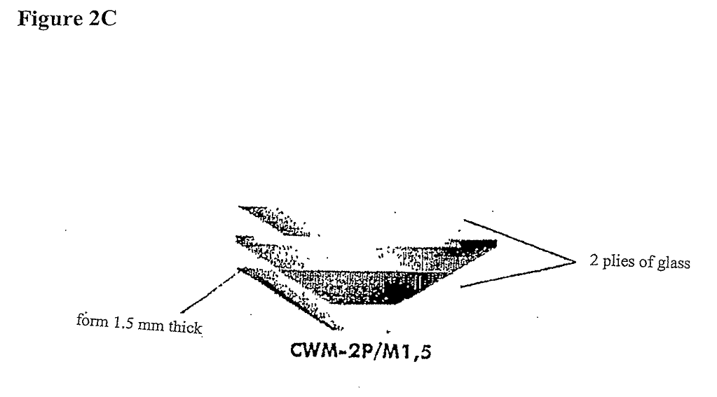

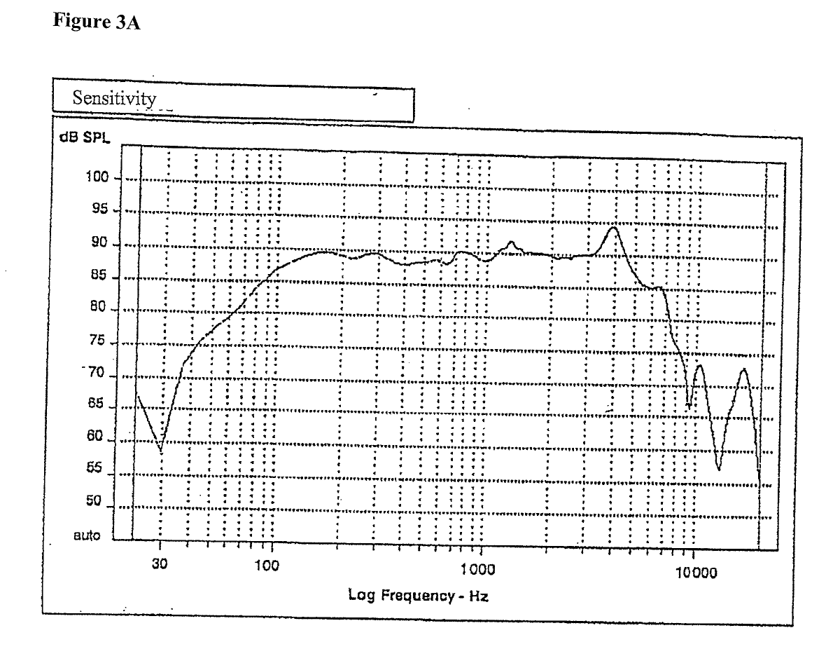

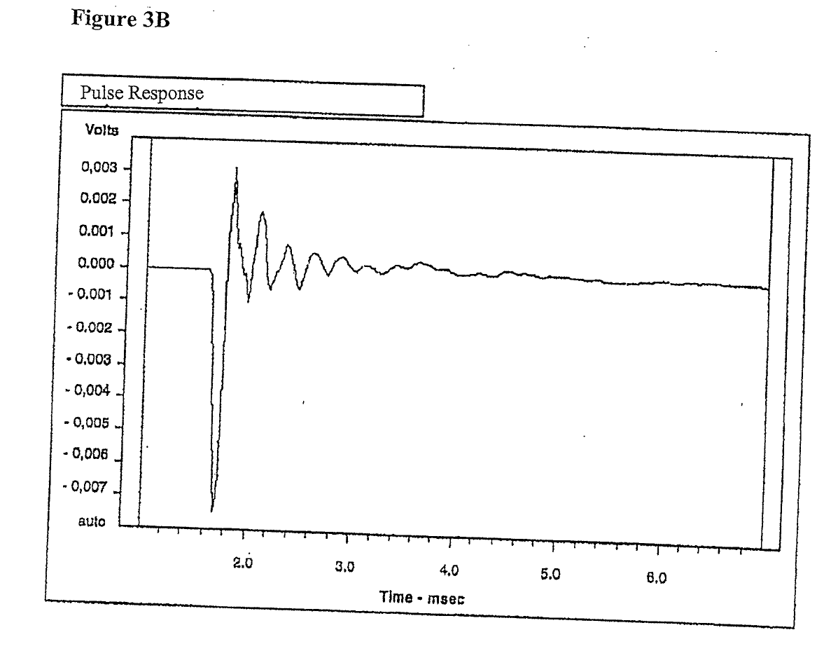

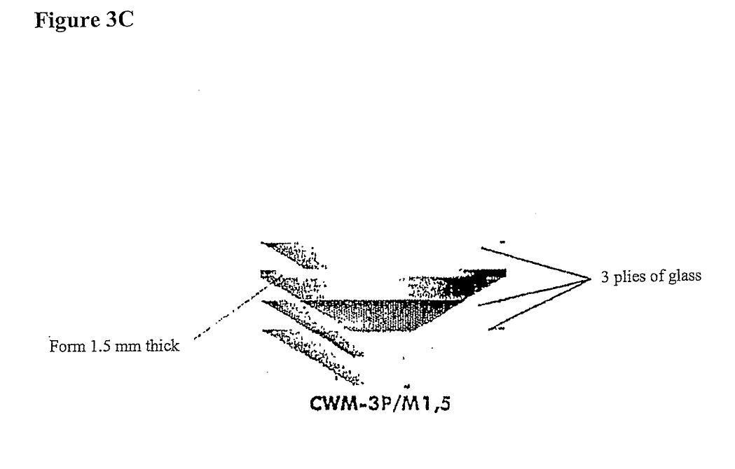

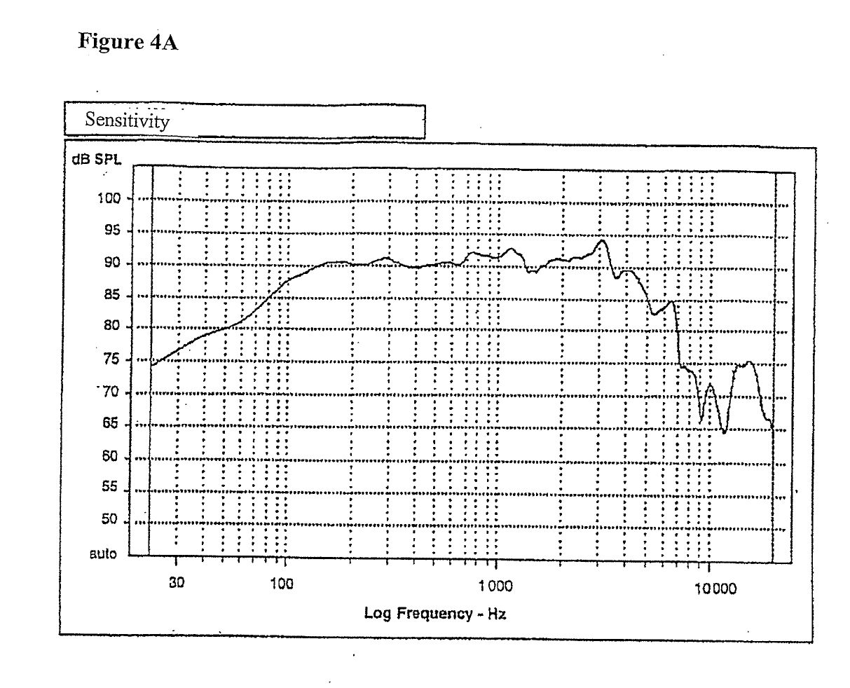

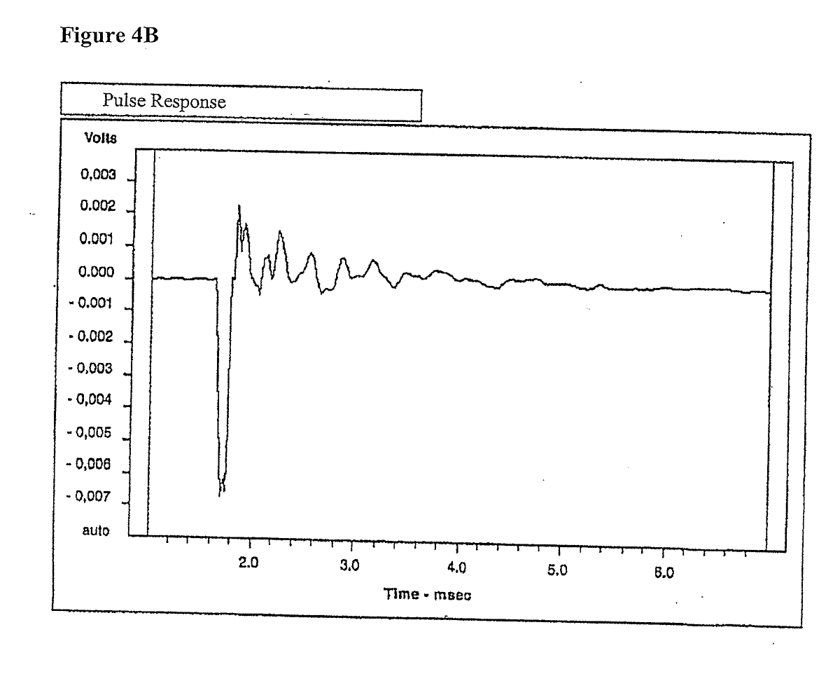

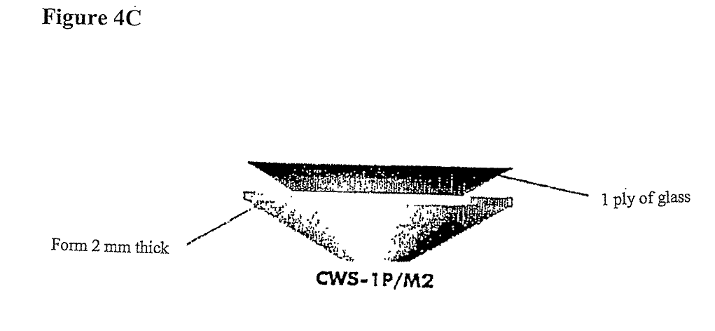

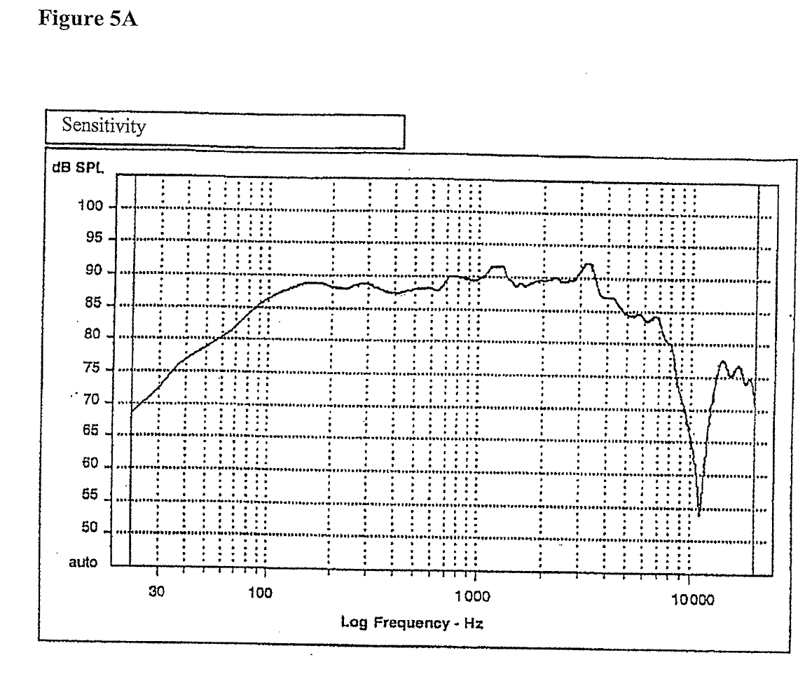

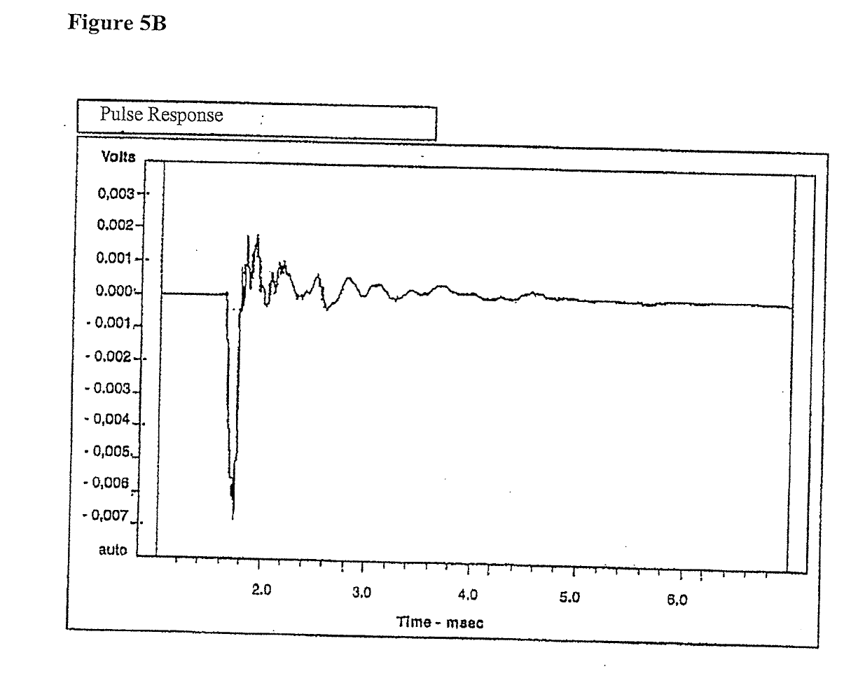

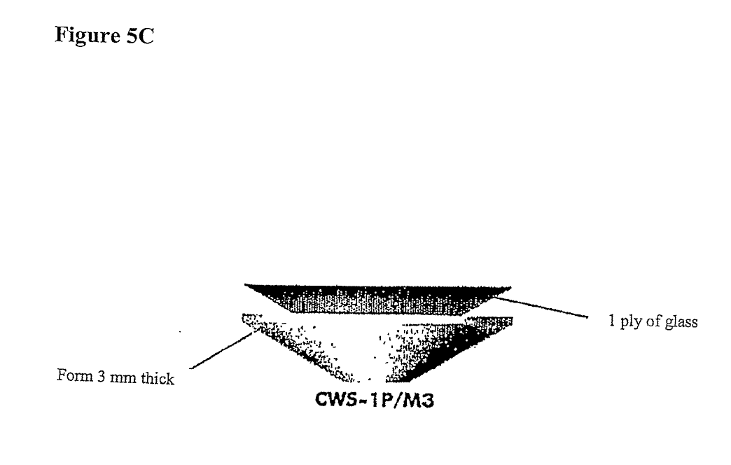

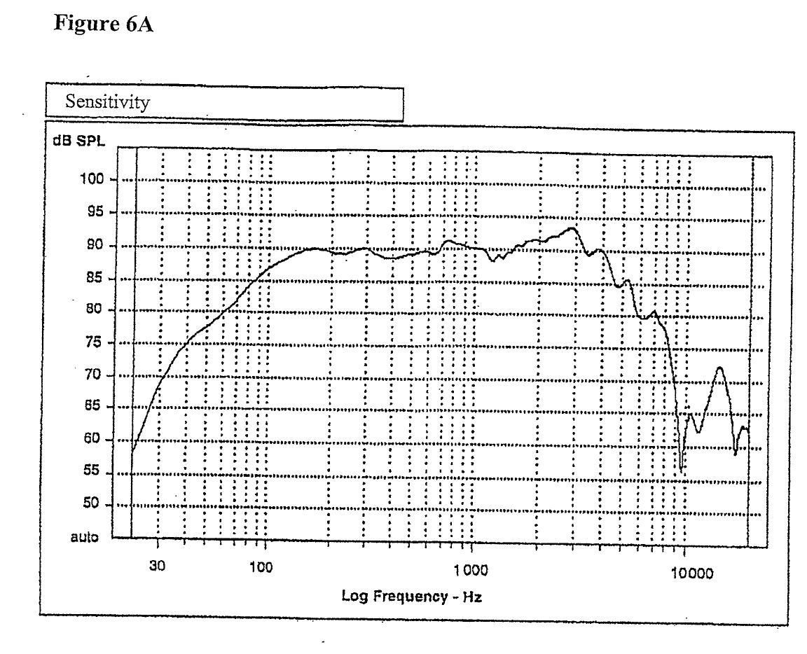

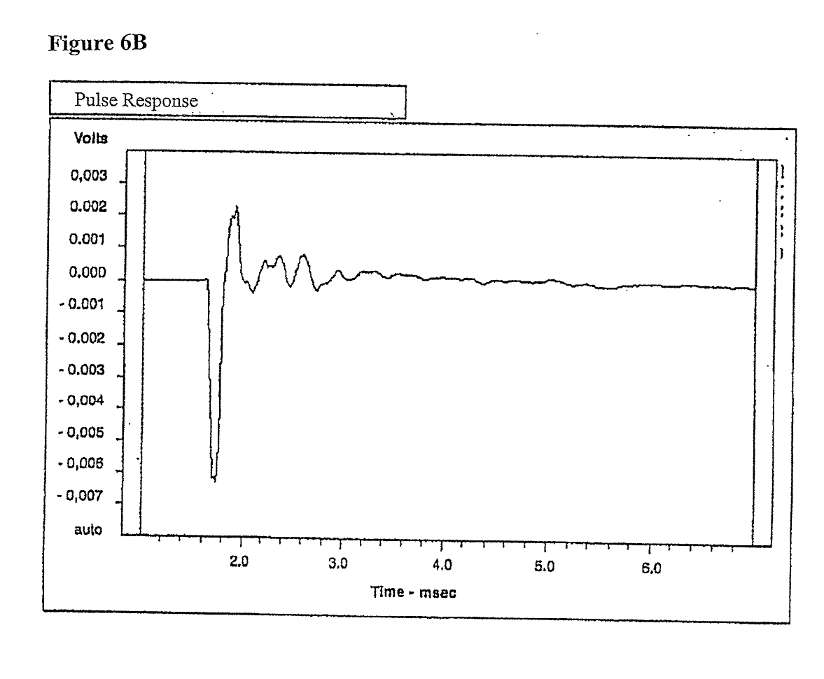

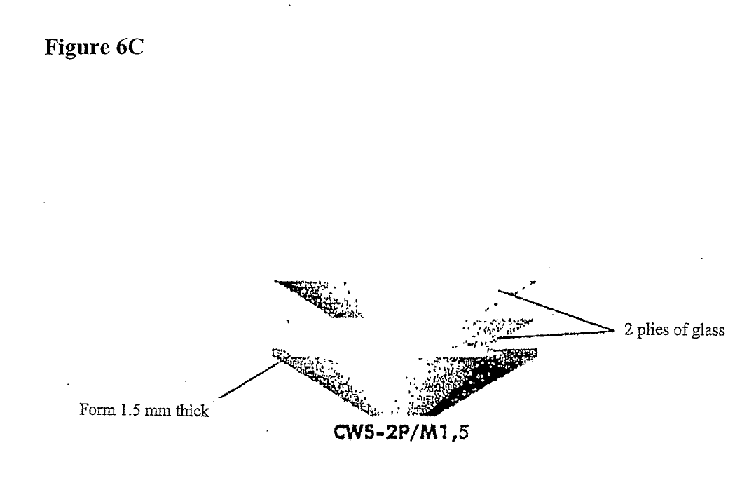

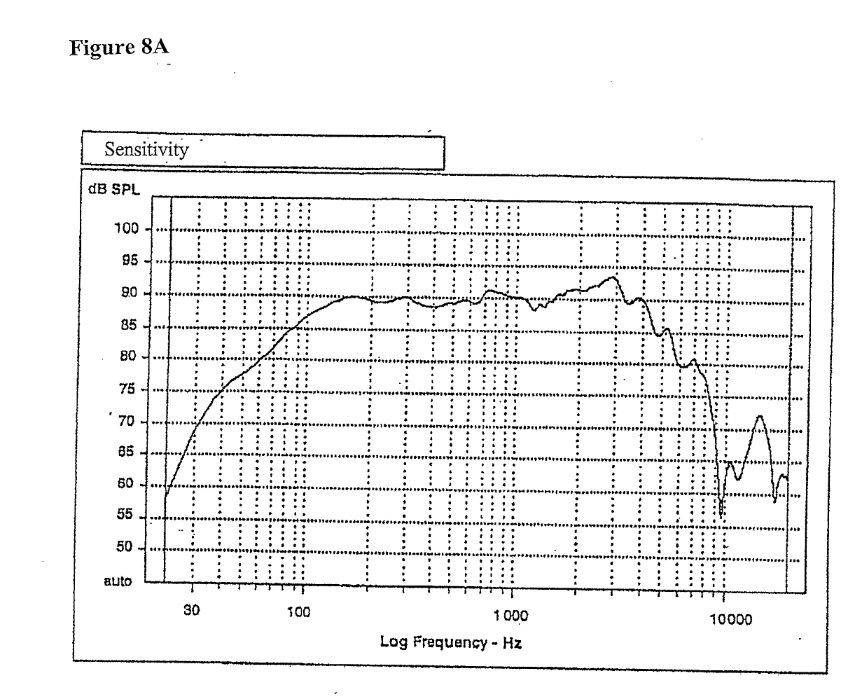

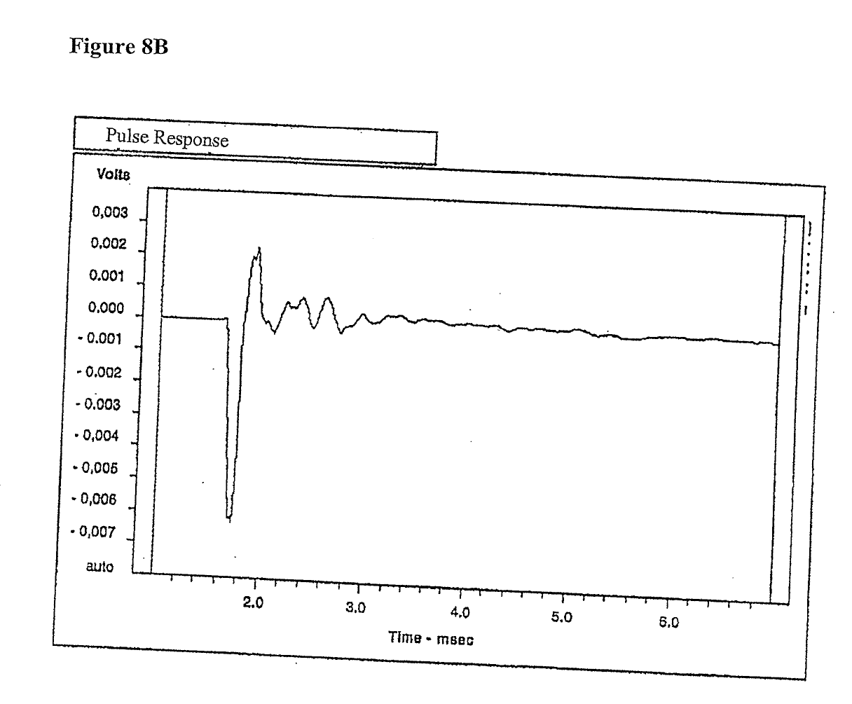

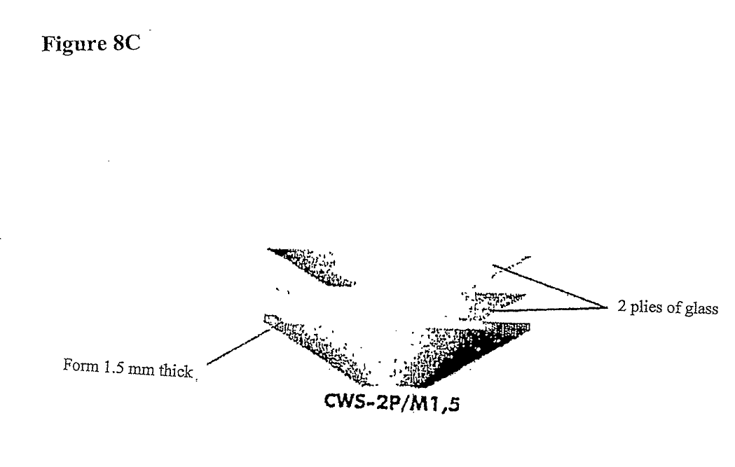

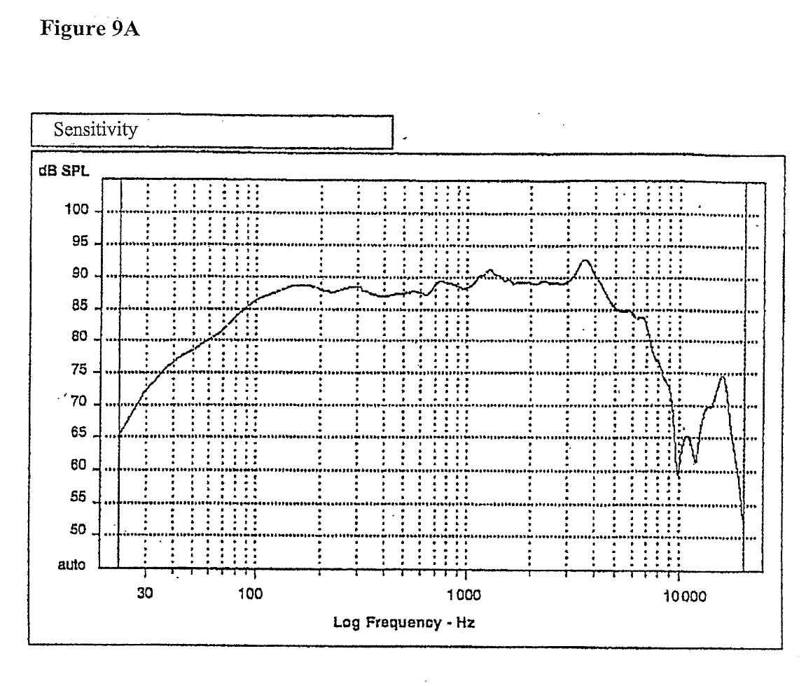

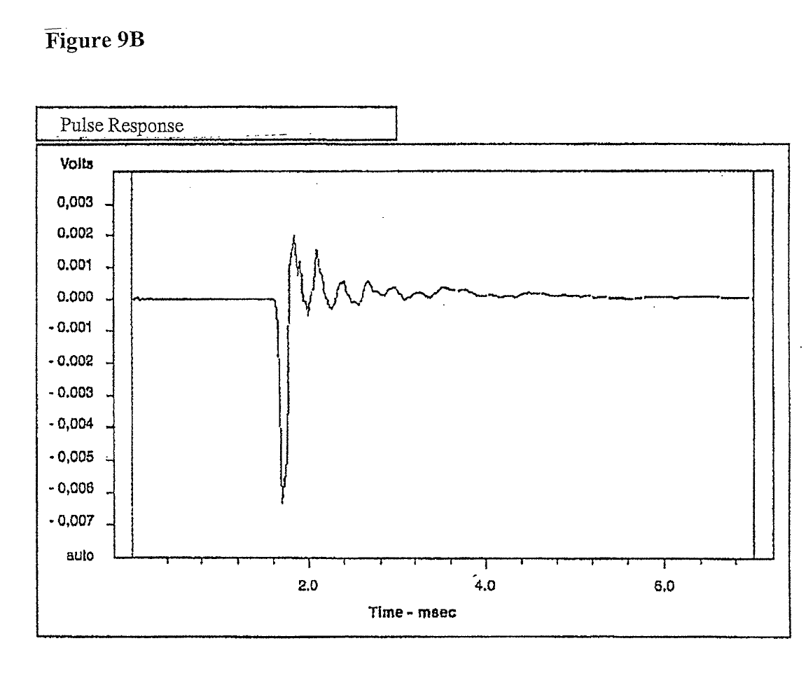

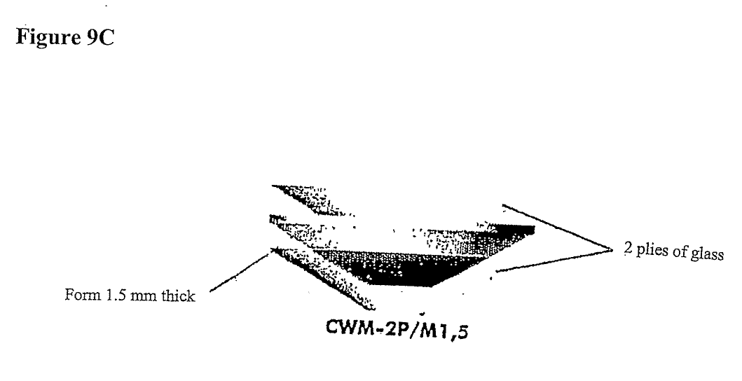

The following embodiments were produced; the sensitivity curves of each structure (Figures X <<A>>) and the pulse response curves (Figures X <<B>> are indicated on the opposite page; the structures given as examples are presented in the form of diagrams in Figures X <<C>>, the plies or skins being separated from the core exclusively for the sake of clarity of presentation.

| | |
|---|---|
| CWM-L or CWM-2F/M 1.5 | FIG. 2C, 9C |
| 1 inner glass ply, | |
| foam core 1.5 mm thick | |
| 1 outer glass ply | |
| (FIGS. 2A and 2B and 9A and 9B) | |
| CWM or CWM-3P/M 1.5 | FIG. 3C |
| 1 inner glass ply, | |
| foam core 1.5 mm thick | |
| 2 inner glass plies | |
| (FIGS. 3A and 3B) | |
| CWS-1P/M2 | FIG. 4C |
| 1 outer glass ply, | |
| foam core 2 mm thick | |
| (FIGS. 4A and 4B) | |
| CWS-1P/M3 | FIG. 5C, 7C |
| 1 outer glass ply, | |
| foam core 3 mm thick | |
| (FIGS. 5A and 5B) | |
| CWS-2P/M1.5 | FIG. 6C, 9C |
| 2 outer glass plies | |
| foam core 1.5 mm thick | |
| (FIGS. 6A and 6B and 8B) | |

These figures show (comparative behavior of alternative diaphragms with a common base of 6½″-16.25 cm loudspeakers) that:

1. Effect of number of plies on a sandwich structure with constant core thickness: The rigidity is increased by increasing the number of plies (3 plies CWM-3P/M 1.5, FIGS. 3A/3B, as opposed to 2 plies CWM-2P/M 1.5, FIGS. 2A/2B). The amplitude response is linearized in the 100-1000 Hz band; the pulse is better reproduced and the damping is similar.
2. Effect of core thickness on a sandwich structure: the CWS-1P/M3 structure (FIGS. 5A/5B) has a core 1.5 times thicker than the CWS-1P/M2 structure (FIGS. 4A/4B): its rigidity is increased and the damping is improved. It will be noted that the mass is little affected, since the efficiency of the transducer remains the same. This solution is especially well suited for a “piston stroke” operation in the bass range.
3. Comparative effect of number of plies on the outer skin and of core thickness on a structure with no inner skin:

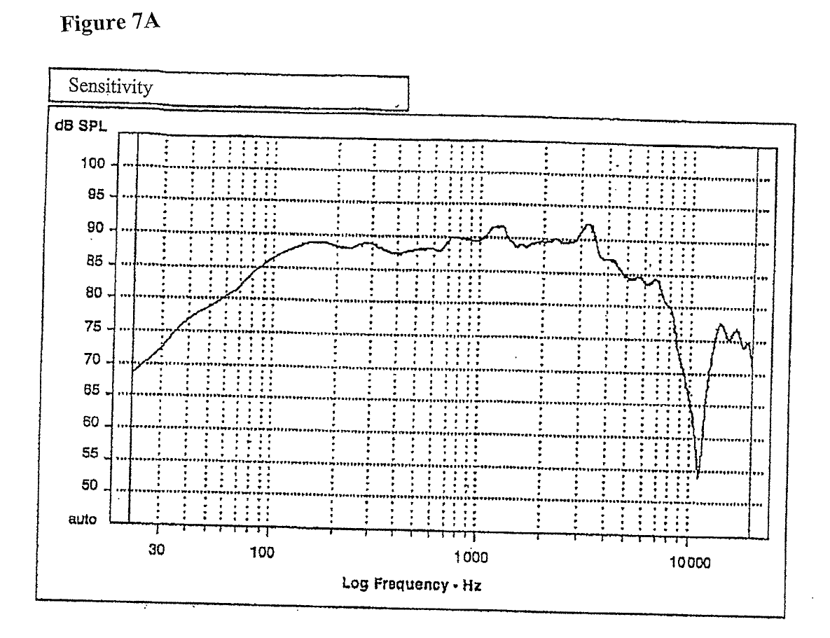

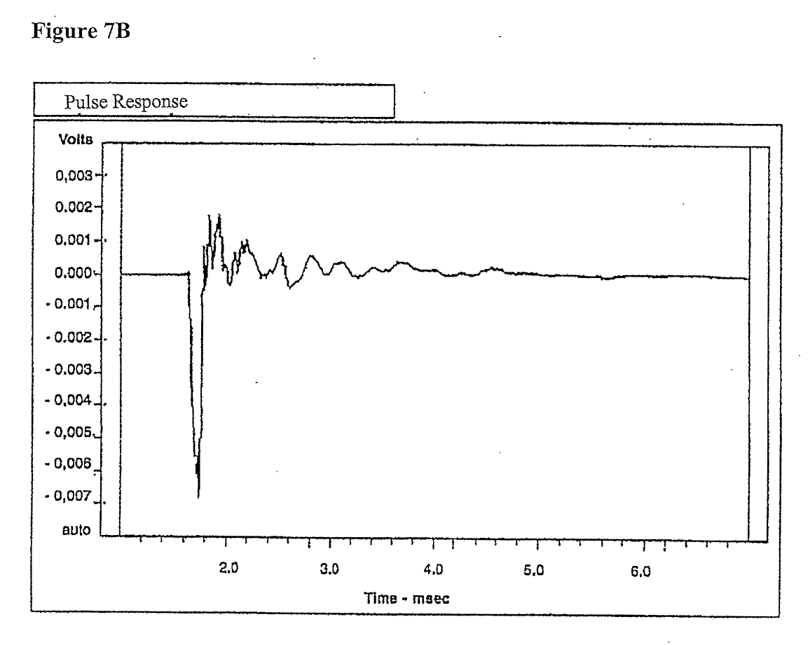

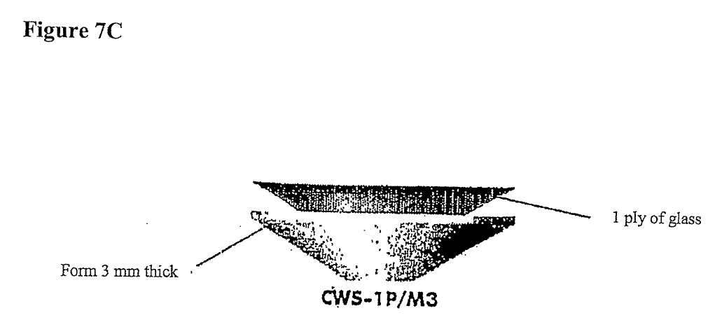

The rigidity is similar; the thinner core (CWS-2P/M 1.5, FIGS. 6A/6B) covered with two outer plies exhibits better pulse behavior, while the CWS-1P/M3 structure (FIGS. 7A/7B) exhibits superior damping with a thicker core.

4. Comparison of a sandwich structure and a structure with no inner skin of the same core thickness:

A CWM-2 P/M 1.5 (FIGS. 9A/9B) is compared to a structure of the same core thickness having no inner skin, CWS-2P/M 1.5 (FIGS. 8A/8B).

The latter, with no inner skin, exhibits better controlled pulse behavior and damping. It is a choice particularly well suited for the medium range.

The best embodiment up to the present, and the most common version for a medium-range loudspeaker, consists of a core 1.5 mm thick with an outer skin of 10 microns produced from two plies of 50-micron glass.

In the case of a 33-cm woofer this core is 3 mm thick and has an inner skin of three 50-micron plies and an outer skin of two 50-micron plies.

The invention also applies to loudspeakers for acoustic baffles having a diaphragm as specified for the invention.

The invention also applies to acoustic baffles provided with at least one loudspeaker comprising a diaphragm as specified for the invention.

Lastly, the invention applies to all applications of such diaphragms, loudspeakers, and acoustic baffles for sound reproduction, specifically high or very high fidelity reproduction, for all private uses, in auditoriums, conference rooms, concert halls, motor vehicles, and other land transportation vehicles, maritime or air transportation vehicles, and the like.

The invention also covers all embodiments and all applications which may be understood immediately by the expert after reading this application, on the basis of his own knowledge, and optionally after conduct of simple routine tests.

1. A diaphragm 1 for a loudspeaker, characterized in that:
such diaphragm 1 comprises a core 2 consisting of structural foam cut with high precision and thermomolded to the geometric shape desired for the diaphragm,
the exterior surface 4 is covered with at least one, preferably a plurality of, “outer plies” 5 of woven or nonwoven fibers impregnated with resin to form a laminate or “outer skin” 6,
The interior surface 7 is covered or not covered with one or more woven or nonwoven “inner plies” to form a laminate or “inner skin 9.”

2. The diaphragm as specified in claim 1, wherein the woven or nonwoven fibers forming the inner and outer plies which are selected are among the following:
glass fibers
carbon fibers, polyethylene fibers, aramides, and para-amides (Dyneema™, Spectra™, Kevlar™, Vectran™)

3. The diaphragm as specified in claim 1, wherein the foam constituting the core selected is among the following:
Plexiglass™ foam with closed cells of a density ranging from 30 to 100 kg/m³, typically 50 kg/m³
PVC (polyvinyl chloride) foam with closed cells of a density ranging from 50 to 200 kg/m³
polystyrene foam with closed cells of a density ranging from 15 to 40 kg/m³

4. The diaphragm as specified in claim 1, wherein the impregnation resin chosen is one of the following:
resins of the thermohardenable type: epoxy, polyester, vinylester, and phenolic ester
thermoplastic resins: polyamide, polypropylene

5. The diaphragm as specified in claim 1, wherein use may be made of different fibers and different impregnation resins, or conversely identical ones, for producing the plies, or also one combination of fibers and resin may be employed for the inner plies and another combination for the outer plies, or the same combination may be employed.

6. The diaphragm as specified in claim 5, wherein the same combination is employed.

7. The diaphragm as specified in claim 1, wherein the thicknesses of the inner and outer plies are modified by cutting the material in different thicknesses ranging from 1.5 mm to 4 mm.

8. The diaphragm as specified in claim 1, wherein such diaphragm exhibits a sandwich structure selected from among the following:
CWM-L or CWM-2P/M 1.5
1 inner ply of glass,
foam core of a thickness of 1.5 mm
1 outer ply of glass
CWM or CWM-3P/M 1.5
1 outer ply of glass,
foam core of a thickness of 1.5 mm
2 inner plies of glass
CWS-1P/M2
1 outer ply of glass
foam core of a thickness of 2 mm
CWS-1P/M3
1 outer ply of glass
foam core of a thickness of 3 mm
CWS-2P/M1.5
2 outer plies of glass
foam core of a thickness of 1.5 mm

9. The diaphragm as specified in claim 1 for bass-range and medium-range transducers the diameters of which vary from 48 cm to 10 cm.

10. The diaphragm as specified in claim 1 for a medium-range loudspeaker, wherein such diaphragm consists of a core of a thickness of 1.5 mm with an outer skin of 100 microns produced from two plies of glass 50 microns.

11. The diaphragm as specified in claim 1 for a woofer 33 cm in diameter, wherein the thickness of the core is 3 mm with an inner skin of 3 plies of 50 microns and an outer skin of two plies of 50 microns.

12. A process for manufacture of a diaphragm as specified in claim 1, characterized in that such sandwich-structure material is polymerized either by compression between mold and countermold or by vacuum molding, at a temperature permitting polymerization of the resin and accordingly production of a mechanically uniform structure.

13. Diaphragms for loudspeakers of acoustic baffles, characterized in that such diaphragms are manufactured by the process as specified in claim 12.

14. Loudspeakers for acoustic baffles, characterized in that such loudspeakers comprise a diaphragm as specified in claim 1.

15. Acoustic baffles, characterized in that such acoustic baffles are provided with at least one loudspeaker as specified in claim 14.

16. Applications of diaphragms, loudspeakers, and acoustic baffles as specified in claim 1 for the reproduction of sounds, especially sounds of high or very high fidelity, for all private uses, in auditoriums, conference rooms, concert halls, automobiles and other land transportation vehicles, maritime or air transportation vehicles, and the like.
